(19) United States
(12) Patent Application Publication
(10) Pub. No.: US 2024/0146673 A1
(43) Pub. Date: May 2, 2024

(54) METHOD FOR CORRECTING PROFILE IMAGE IN ONLINE COMMUNICATION SERVICE AND APPARATUS THEREFOR

(71) Applicant: SAMSUNG SDS CO., LTD., Seoul (KR)

(72) Inventor: Hayang KIL, Seoul (KR)

(73) Assignee: SAMSUNG SDS CO., LTD., Seoul (KR)

(21) Appl. No.: 18/493,110

(22) Filed: Oct. 24, 2023

(30) Foreign Application Priority Data
Oct. 28, 2022 (KR) 10-2022-0141252

(51) Int. Cl. H04L 51/043; G06F 3/01; G06T 7/11; G06T 11/00; G06V 40/16

(52) U.S. Cl. CPC H04L 51/043; G06F 3/012; G06T 7/11; G06T 11/00; G06V 40/171; G06V 40/174; G06T 2200/24; G06T 2207/30201

(57) ABSTRACT

A processor-implemented method for correcting a profile image in an online communication service including extracting emotion information of a terminal user based on user input information and correcting a profile image of the terminal user based on the extracted emotion information

### CROSS-REFERENCE TO RELATED APPLICATIONS

This application claims the benefit under 35 USC § 119(a) of Korean Patent Application No. 10-2022-0141252 filed on Oct. 28, 2022, in the Korean Intellectual Property Office, the entire disclosure of which is incorporated herein by reference for all purposes.

### BACKGROUND

### 1. Field of the Invention

The disclosure relates to an online communication service and, more specifically, to a method for correcting a profile image based on a user's emotion and a device therefor.

### 2. Description of the Prior Art

In online communication services such as messengers or video conferences, a method of using text or emoticons is used to convey a user's emotions to a counterpart. In particular, emoticons are mainly used to convey the user's emotions more effectively.

An emoticon is a symbol used to represent a user's emotions, and is a term blending an emotion and an icon. In the early days, emoticons have been made with a simple combination of various symbols and letters on a keypad, but recently they have been developed into emojis that represent the user's emotions through various types of characters. As service users' demand for such emoticons increases, provision of various types of emoticons to service users has become common in online communication services.

However, it is not a perfect substitute for face-to-face communication because the other party's emotion can only be inferred through the emoticons in a chat window and the other party's expression cannot be actually seen. Therefore, there is a need for a method of more effectively conveying a user's emotions to the other party in an online communication service.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method for correcting a profile image in an online communication service including extracting emotion information of a terminal user based on user input information and correcting a profile image of the terminal user based on the extracted emotion information.

The user input information may include message information received from an input of the terminal user, and the message information may include one or both of text information and emoticon information.

The extracting may include inputting the message information to a pre-trained text analysis model to extract the emotion information of the terminal user.

The emotion information of the terminal user may include one or both of information about a type of emotion and information about an intensity of emotion.

The method may include detecting the profile image of the terminal user and determining whether the detected profile image is of an image type capable of conveying emotions.

The correcting may include extracting a face region of a person included in the profile image by using an object tracking algorithm and correcting a facial expression included in the extracted face region according to the extracted emotion information, by using an image synthesis algorithm.

The method may include transmitting the corrected profile image to a user terminal.

The method may include receiving user image information including a face image of the terminal user from a user terminal.

The user input information may include message information input from the terminal user and typing speed information of the terminal user.

The extracting may include extracting the emotion information of the terminal user based on one or more of first emotion information extracted through the message information, second emotion information extracted through the typing speed information, and third emotion information extracted through the user image information.

The extracting may include inputting the typing speed information to a pre-trained typing analysis model to extract the second emotion information.

The extracting further may include extracting feature points of the face image included in the user image information by using an image shift algorithm and extracting the third emotion information based on the extracted feature points.

The method may include determining whether the profile image of the terminal user is of an image type capable of conveying emotions and generating a new profile image based on a face image included in the user image information responsive to the profile image being an image type incapable of conveying emotions.

The method may include determining whether a first face included in the profile image of the terminal user matches a second face included in the user image information responsive to the profile image being the image type incapable of conveying emotions and generating a new profile image based on the face image included in the user image information responsive to the first face not matching the second face.

The method may include determining whether a chat room of the online communication service is a chat room in which emotions can be expressed, based on chat room message information displayed in the chat room.

The determining may include determining an atmosphere of the chat room based on the chat room message information displayed in the chat room, by using a pre-trained chat room analysis model and determining whether the chat room is a chat room in which emotions can be expressed responsive to the determining of the atmosphere.

The method may include generating one or more candidate profile images including facial expressions different from facial expressions included in the corrected profile image responsive to a profile image change request of the terminal user and providing the generated candidate profile images to a user terminal.

In a general aspect, here is provide a profile image correction device in an online communication service, the profile image correction device including one or more processors configured to execute instructions and a memory storing the instructions, and execution of the plurality of instructions configures one or more of the processors to extract emotion information of a terminal user based on user input information and perform a correction of a profile image of the terminal user based on the extracted emotion information.

The user input information may include message information received from the terminal user, and the message information may include one or both of text information and emoticon information.

In a general aspect, here is provided a non-transitory, computer-readable storage medium storing instructions that, when executed by the one or more processors, configure the one or more processors to receive user input information from a user terminal of an online communication service, extract emotion information of a terminal user based on the received user input information, and correct a profile image of the terminal user based on the extracted emotion information.

### BRIEF DESCRIPTION OF THE DRAWINGS

FIG. 1 illustrates a configuration of an online communication system according to an embodiment of the disclosure;

FIG. 2 is a flowchart illustrating a profile image correction method according to an embodiment of the disclosure;

FIGS. 3A and 3B are a diagram referenced to illustrate the profile image correction method of FIG. 2;

FIG. 4 is a flowchart illustrating a profile image correction method according to another embodiment of the disclosure;

FIGS. 5A to 5D are diagrams for reference to explain a method for the profile image replacement FIG. 4;

FIGS. 6A to 6D are diagrams for reference to explain a method for the candidate profile image selection of FIG. 4; and

FIG. 7 is a configuration block diagram of a computing device according to an embodiment of the disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

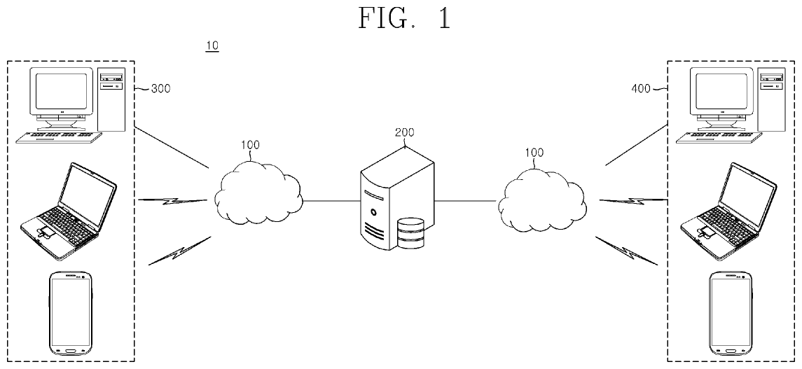

FIG. 1 illustrates the configuration of an online communication system according to an embodiment of the disclosure.

Referring to FIG. 1, an online communication system 10 according to an embodiment of the disclosure may include a communication network 100, a service providing server 200, a user terminal 300, and a counterpart terminal 400.

The service providing server 200 and the user terminal 300 may be connected to each other through the communication network 100. Similarly, the service providing server 200 and the counterpart terminal 400 may be connected to each other through the communication network 100. The communication network 100 may include a wired network and a wireless network, and specifically, may include various networks such as, a local area network (LAN), a metropolitan area network (MAN), and a wide area network (WAN). In addition, the communication network 100 may include the well-known World Wide Web (WWW). However, the communication network 100 according to the disclosure is not limited to the networks listed above, and may include at least one of a known wireless data network, a known telephone network, and a known wired/wireless television network.

The service providing server 200 may provide an online communication service requested by the user terminal 300 and the counterpart terminal 400. The online communication service described in this embodiment may include all online conversation services such as a messenger service, a chatting service, a video conference service, a message service, and a social network service (operation SNS) service.

For example, when the service providing server 200 is a messenger server, the service providing server 200 may provide a messenger service to the user terminal 300 and the counterpart terminal 400. Meanwhile, as another example, when the service providing server 200 is a video conference server, the service providing server 200 may provide a video conference service to the user terminal 300 and the counterpart terminal 400.

The service providing server 200 may include a profile image correction device for correcting a profile image on the online communication service. The profile image correction device may extract an emotion of a terminal user based on at least one of user input information and user face information, and automatically correct a profile image based on the extracted emotion. A detailed description of the profile image correction device and method thereof will be described later.

The user terminal 300 and the counterpart terminal 400 may provide an online communication service based on information provided from the service providing server 200. For example, when the service providing server 200 is a messenger server, the user terminal 300 and the counterpart terminal 400 may provide a messenger service based on information provided from the messenger server. Meanwhile, as another example, when the service providing server 200 is a video conference server, the user terminal 300 and the counterpart terminal 400 may provide a video conference service based on information provided from the video conference server.

The user terminal 300 and the counterpart terminal 400 may download and install a program or application for providing an online communication service. At this time, the user terminal 300 and the counterpart terminal 400 access the app store, play store, website, etc., to download the program or application, or download the program or application through a separate storage medium.

As the user terminal 300 and the counterpart terminal 400 described herein, a mobile phone, a smart phone, a laptop computer, a desktop computer, a digital broadcasting terminal, and personal digital assistants (PDAs), a portable multimedia player (PMP), a slate PC, a tablet PC, an ultrabook, a wearable device, and the like may be used, but are not necessarily limited thereto.

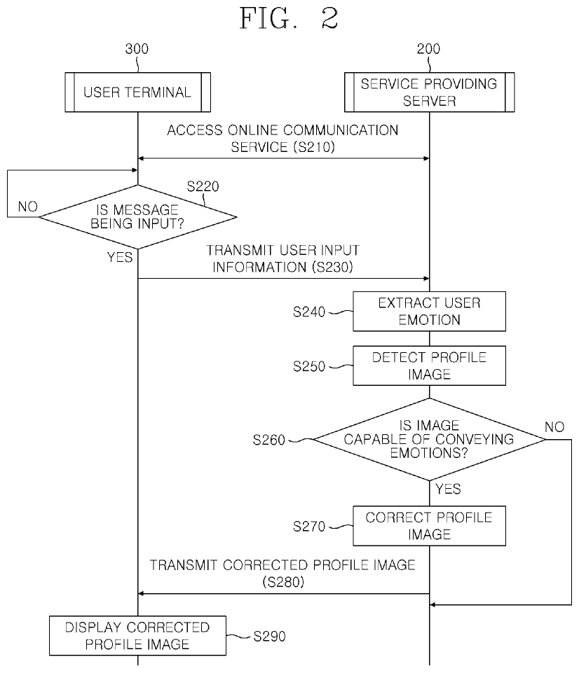

FIG. 2 is a flowchart illustrating a profile image correction method according to an embodiment of the disclosure. The profile image correction method according to the present embodiment may be performed by a profile image correction device (not shown) of the service providing server 200. The profile image correction device may operate in conjunction with the user terminal 300. The profile image correction device may be implemented through a computing device including one or more processors and a memory. In the illustrated flowchart, the profile image correction method is divided into a plurality of operations, but at least some of the operations are performed in reverse order, performed together in combination with other operations, omitted, performed in detailed operations, or performed with the addition of one or more operations not yet described.

Referring to FIG. 2, the user terminal 300 may, according to a user command, access the service providing server 200 and provide an online communication service to a terminal user (operation S210).

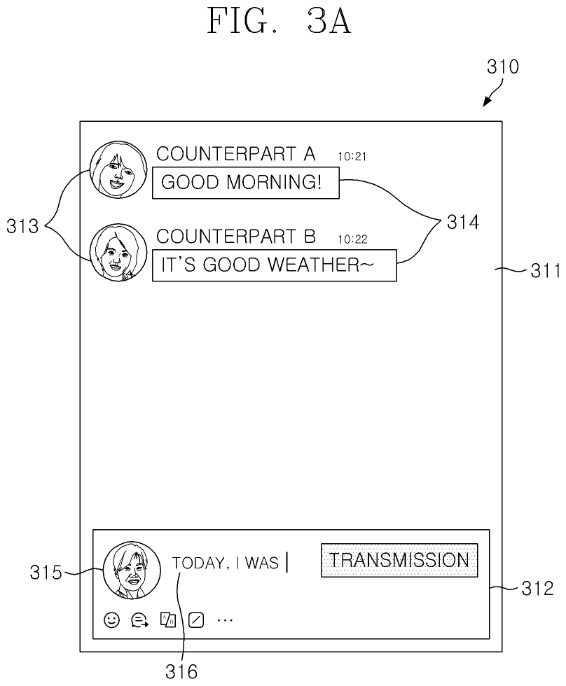

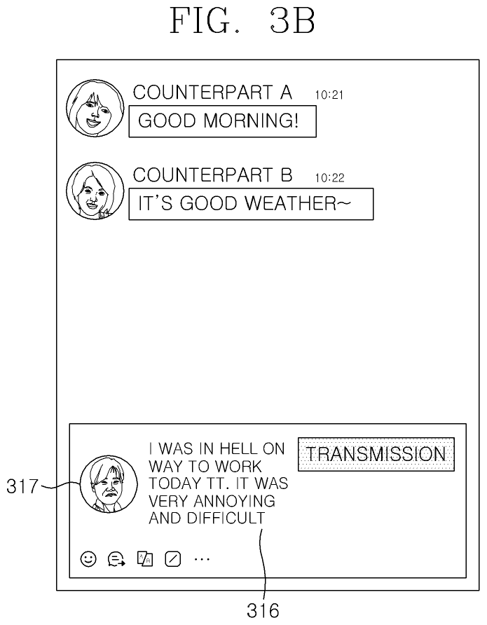

For example, as shown in FIG. 3A, the user terminal 300 may display a service screen 310 including a chat window 311 and an input window 312 on the display unit. A profile image 313 of a conversation partner, a message 314 of a conversation partner, a profile image of a terminal user (not shown), a message of a terminal user (not shown), and the like may be displayed in the chat window 311. Here, the profile image of a terminal user may be configured to be omittable. A profile image 315 of a terminal user may be displayed in an area of the input window 312.

The user terminal 300 may identify whether a terminal user's message is input through the input window of the service screen (operation S220).

As a result of the identification in operation 220, in case that the terminal user's message is input, the user terminal 300 may provide user input information to the service providing server 200 (operation S230). Here, the user input information may include message information input from a terminal user. The message information may include at least one of text information and emoticon information.

For example, as shown in FIG. 3A, in case that a terminal user's message is input, the user terminal 300 may display input message information 316 on an input window 315 of a user screen 310. At the same time, the user terminal 300 may transmit the input message information 316 to the service providing server 200.

The service providing server 200 may extract emotion information of the terminal user based on the user input information received from the user terminal 300 (operation S240). Here, the emotion information of the terminal user may include at least one of information about a type of emotion and information about an intensity of emotion. Types of emotions include happy, sadness, anger, depression, surprise, and the like, but are not necessarily limited thereto. The intensity of the emotion includes very happy, happy, and little joy, but is not necessarily limited thereto. Meanwhile, the intensity of the emotion may be represented through numerical values.

For example, the service providing server 200 may input message information, which is input from a terminal user, to a pre-trained text analysis model to extract a user's emotion information. The text analysis model, as a kind of machine learning model, may be pre-implemented through machine learning on message data according to the user's emotional state.

The service providing server 200 may detect a profile image of the terminal user (operation S250).

The service providing server 200 may identify whether the detected profile image is an image capable of conveying emotions (operation S260). For example, the service providing server 200 may identify whether the detected profile image includes facial expressions capable of conveying emotions.

As a result of the identification in operation 260, in case that the corresponding profile image is an image capable of conveying emotions, the service providing server 200 may correct the profile image based on the extracted emotion information of a user (operation S270). That is, the service providing server 200 may apply the user's emotion to the facial expression of the profile image.

For example, the service providing server 200 may extract a face region of a person included in a profile image by using an object tracking algorithm. The service providing server 200 may correct the expression included in the extracted face region to match the extracted emotion of the user. At this time, the service providing server 200 may correct the facial expression of the profile image by using an image synthesis algorithm (e.g., deepfake technology based on generative adversarial networks (GAN)).

The service providing server 200 may provide the corrected profile image to the user terminal 300 (operation S280).

The user terminal 300 may display the corrected profile image, received from the service providing server 200, on the service screen (operation S290). For example, as shown in FIG. 3B, the user terminal 300 may change a basic profile image or a profile image 311 of a previous state to a corrected profile image 317 received from the service providing server 200 and display the corrected profile image 317.

Meanwhile, as a result of the identification in operation 260, in case that the corresponding profile image is an image incapable of conveying emotions, the service providing server 200 may maintain the current profile image as it is without separate profile image correction.

Thereafter, the user terminal 300 may, in response to a message transmission command of the terminal user, transmit a message transmission request signal to the service providing server 200. Upon receiving the message transmission request signal, the service providing server 200 may transmit the corrected profile image and the message of the terminal user to the counterpart terminal 400. The counterpart terminal 400 may display the corrected profile image and the message, received from the service providing server 200, on the service screen.

As described above, according to the method for correcting a profile image according to an embodiment of the disclosure, a terminal user's emotion may be extracted based on user input information obtained from a user terminal, and a profile image of an online communication service may be corrected automatically based on the extracted emotion. According to the profile image correction method, the facial expression of the profile image displayed on the online communication service screen is changed in real time, and thus the emotions of the terminal user can be effectively conveyed to a conversation partner and a lively and immersive conversation can be exchanged with the conversation partner.

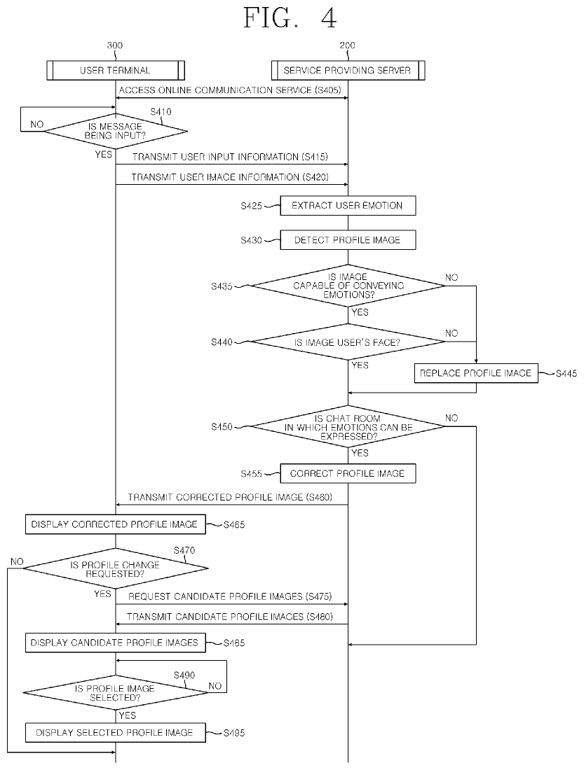

FIG. 4 is a flowchart illustrating a profile image correction method according to another embodiment of the disclosure. The profile image correction method according to this embodiment may be performed by a profile image correction device (not shown) of the service providing server 200. The profile image correction device may operate in conjunction with the user terminal 300. The profile image correction device may be implemented through a computing device including one or more processors and memory. In the illustrated flowchart, the profile image correction method is divided into a plurality of operations and illustrated, but at least some of the operations are performed in reverse order, performed together in combination with other operations, omitted, performed in detailed operations, or performed with the addition of one or more operations not yet shown.

Referring to FIG. 4, the user terminal 300 may, according to a user command, access the service providing server 200 and provide an online communication service to a terminal user (operation S405).

The user terminal 300 may identify whether a terminal user's message is input through the input window of the service screen (operation S410).

As a result of the identification in operation S410, in case that the terminal user's message is input, the user terminal 300 may provide user input information to the service providing server 200 (operation S415). Here, the user input information may include message information input from a user and typing speed information of the user. The message information may include at least one of text information and emoticon information. The typing speed information may be measured based on message information input from a terminal user.

The user terminal 300 may acquire user image information including the user's face by automatically activating a camera when the terminal user inputs a message. Meanwhile, in another embodiment, the user terminal 300 may acquire user image information by activating a camera according to a request command of the service providing server 200.

The user terminal 300 may provide the user image information acquired through the camera to the service providing server 200 (operation S420).

The service providing server 200 may extract emotion information of the terminal user based on the user input information and the user image information received from the user terminal 300 (operation S425). Here, the emotion information of the terminal user may include at least one of information about a type of emotion and information about an intensity of emotion. Types of emotions include happy, sadness, anger, depression, surprise, and the like, but are not necessarily limited thereto. The intensity of the emotion includes very happy, happy, and little joy, but is not necessarily limited thereto. Meanwhile, the intensity of the emotion may be expressed through numerical values.

For example, the service providing server 200 may input message information, which is input from a user, to a pre-trained text analysis model to so as extract first emotion information of the terminal user. The text analysis model, as a kind of machine learning model, may be pre-implemented through machine learning on message data according to the user's emotional state.

The service providing server 200 may input the user's typing speed information to the pre-trained typing analysis model to extract second emotion information of the terminal user. Similarly, the typing analysis model, as a type of machine learning model, may be pre-implemented through machine learning on typing speed data according to the user's emotional state.

The service providing server 200 may extract feature points of a face image included in user image information, and may extract third emotion information of the terminal user based on the extracted feature points. In this case, the service providing server 200 may extract feature points of the face image by using an image shift algorithm, such as a Mean-Shift algorithm or a CAMshift algorithm.

The service providing server 200 may extract emotion information of the terminal user based on first and second emotion information extracted through user input information and third emotion information extracted through user image information. Meanwhile, as another embodiment, the service providing server 200 may extract emotion information of the terminal user based on at least one of the first to third emotion information.

The service providing server 200 may detect a profile image of the terminal user (operation S430).

The service providing server 200 may identify whether the detected profile image is an image capable of conveying emotions (operation S435). For example, the service providing server 200 may identify whether the detected profile image includes facial expressions capable of conveying emotions.

As a result of the identification in operation S435, in case that the corresponding profile image is an image capable of conveying emotions, the service providing server 200 may identify whether the face included in the profile image and the face included in the user image information match each other (operation S440). This is because the profile image of the terminal user may include people (e.g., family members, celebrities, etc.) other than the terminal user himself or herself.

Meanwhile, as a result of the identification in operation 435, in case that the corresponding profile image is an image incapable of conveying emotions, the service providing server 200 may replace the current profile image by a new profile image (operation S445). In this case, the new profile image may include the terminal user's face. In addition, the new profile image may include a facial expression to which emotions of the terminal user are applied.

For example, the service providing server 200 may generate a new profile image by extracting a face image included in user image information and correcting the expression of the extracted face image to match the user's emotion. The service providing server 200 may provide the new profile image to the user terminal 300.

As a result of the identification in operation 440, in case that the face included in the profile image of the terminal user and the face included in the user image information match each other, the service providing server 200 may identify whether the current chat room is a chat room in which emotions can be expressed (operation S450). This identification is to determine whether to apply the emotion information of the terminal user to the profile image according to the situation or atmosphere of the chat room.

For example, the service providing server 200 may identify the atmosphere of the chat room based on message information displayed in the chat room by using a pre-trained chat room analysis model, and may identify whether the chat room is a chat room in which emotions can be expressed, based on the identified atmosphere. Here, the chat room analysis model may be pre-implemented through machine learning on message data according to the atmosphere of the chat room.

Meanwhile, as a result of the identification in operation 440, in case that the face included in the profile image of the terminal user and the face included in the user image information do not match each other, the service providing server 200 may replace the current profile image by a new profile image (operation S445). In this case, the new profile image may include the terminal user's face. In addition, the new profile image may include a facial expression to which emotions of the terminal user are applied.

As a result of the identification in operation 450, in case that the current chat room is a chat room in which emotions can be expressed, the service providing server 200 may correct the profile image based on the extracted emotion information of a user (operation S455). That is, the service providing server 200 may apply the user's emotion to the facial expression of the profile image.

For example, the service providing server 200 may extract a face region of a person included in a profile image by using an object tracking algorithm. The service providing server 200 may correct the expression included in the extracted face region to match the extracted emotion of the user. At this time, the service providing server 200 may correct the facial expression of the profile image by using an image synthesis algorithm (e.g., deepfake technology based on generative adversarial networks (GAN)).

Meanwhile, although not shown in the drawing, the service providing server 200 may identify whether the terminal user's facial expression is included in the current profile image at the time of correcting the profile image. As a result of the identification, in case that the terminal user's facial expression exists in the current profile image, the service providing server 200 may identify whether the terminal user's facial expression matches the extracted emotion of the user. As a result of the identification, in case that the facial expression of the terminal user matches the extracted emotion of the user, the service providing server 200 may maintain the current profile image as it is. Meanwhile, as a result of the identification, in case that the facial expression of the terminal user does not match the extracted emotion of the user, the service providing server 200 may correct the current profile image.

The service providing server 200 may provide the corrected profile image to the user terminal 300 (operation S460).

The user terminal 300 may display the corrected profile image, which is received from the service providing server 200, on the service screen (operation S465).

On the other hand, in case that the facial expression of the corrected profile image displayed on the service screen does not match the current emotional state of the terminal user, the terminal user may select another profile image having a facial expression suitable for the context (or intention) of a conversation message input by the terminal user.

The user terminal 300 may identify whether a profile change request command is input from the terminal user (operation S470). The profile change request command may be input through a user input of selecting a profile image area of the service screen.

As a result of the identification in operation 470, in case that the profile change request command is input, the user terminal 300 may transmit a signal requesting one or more candidate profile images having facial expressions different from those of the corrected profile image to the service providing server 200 (operation S475).

The service providing server 200 may, in response to a request signal from the user terminal, generate one or more candidate profile images and provide the generated candidate profile images to the user terminal 300 (operation S480).

The user terminal 300 may display one or more candidate profile images, received from the service providing server 200, on an area of the service screen (operation S485).

In case that any one of the candidate profile images displayed on the service screen is selected, the user terminal 300 may change the corrected profile image to the selected candidate profile image and display the selected candidate profile image (operation S495).

Meanwhile, as a result of the identification in operation 470, in case that the profile change request command is not input, the user terminal 300 may maintain the corrected profile image as it is.

Thereafter, the user terminal 300 may, in response to a message transmission command of the terminal user, transmit a message transmission request signal to the service providing server 200. Upon receiving the message transmission request signal, the service providing server 200 may transmit the current profile image and message of the terminal user to the counterpart terminal 400. The counterpart terminal 400 may display the profile image and message, received from the service providing server 200, on the service screen.

As described above, the method for correcting a profile image according to an embodiment of the disclosure extracts a terminal user's emotion based on user input information and user image information obtained from a user terminal, and automatically correct the profile image of the online communication service based on the extracted emotion. The profile image correction method changes the facial expression of the profile image displayed on the online communication service screen in real time, so that the emotions of the terminal user can be effectively conveyed to a conversation partner, and a lively and immersive conversation can be exchanged with the conversation partner.

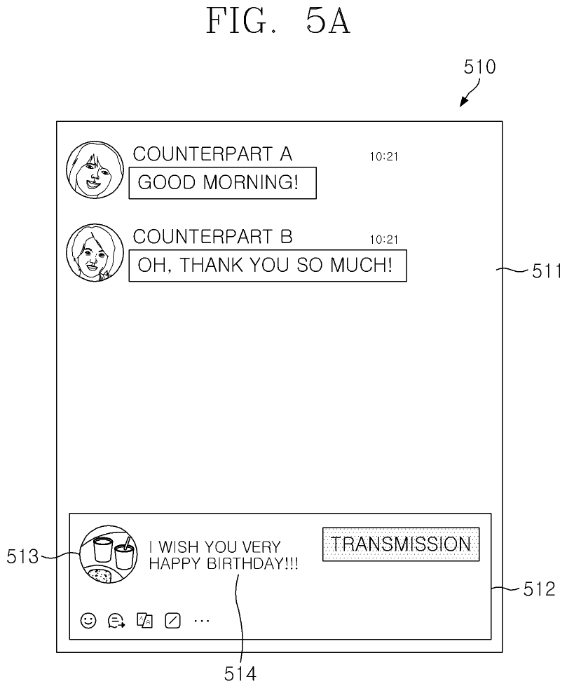

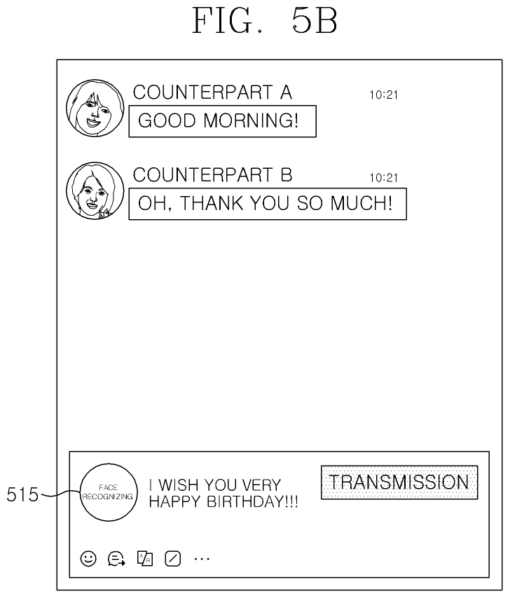

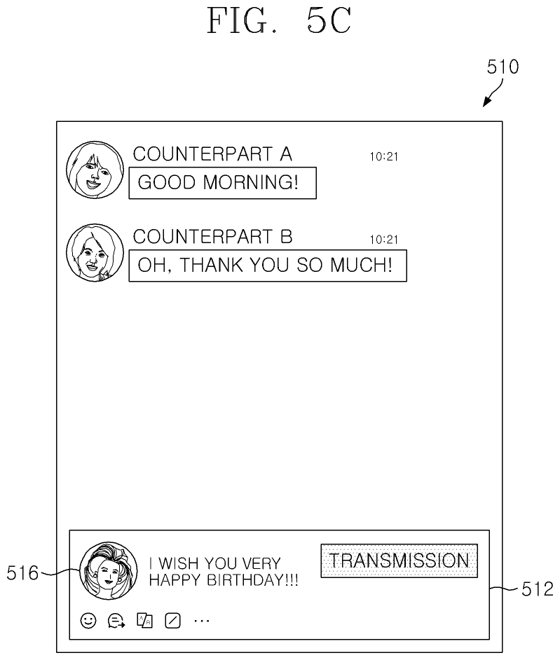

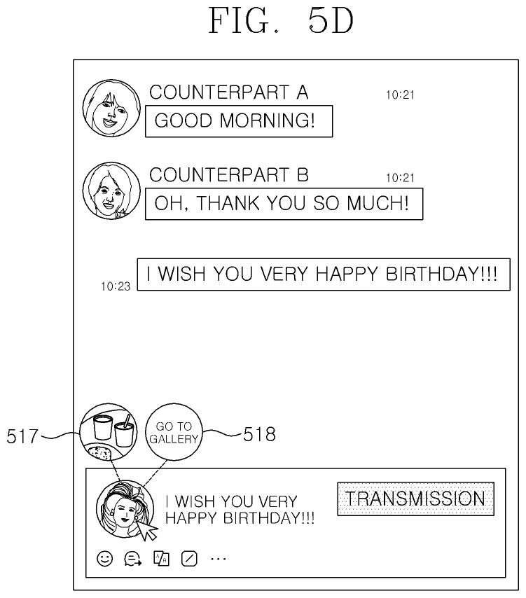

FIGS. 5A to 5D are diagrams for reference to explain a method for profile image replacement of FIG. 4.

Referring to FIGS. 5A to 5D, the user terminal 300 may display a service screen 510 including a chat window 511 and an input window 512 on the display unit. A profile image 513 of the terminal user may be displayed on the input window 512.

When a terminal user inputs a predetermined message 514 through the input window 512 of the service screen 510, the service providing server 200 may extract the terminal user's emotion based on the input message 514, and may identify whether the profile image 513 of the terminal user is an image capable of conveying emotions. As a result of the identification, when the terminal user's profile image 513 is an object image incapable of conveying emotions, the service providing server 200 may extract a face image included in the user image information, and correct the facial expression of the extracted face image to match a user's emotion so as to generate a new profile image 516. At this time, the user terminal 300 may display, on the service screen 510, an indicator 515 indicating that a new profile image is currently being generated.

The service providing server 200 may provide a new profile image 516 to the user terminal 300. The user terminal 300 may display the profile image 516 received from the service providing server 200 on the service screen 510. That is, the user terminal 300 may change the current profile image 513 to a new profile image 516 and display the new profile image 516.

Meanwhile, the terminal user may select a profile image other than the profile image 516 provided (or recommended) by the service providing server 200. For example, when a terminal user selects a profile image area of the service screen 510, the user terminal 300 may display an image icon 517 for selecting a basic profile image and a gallery icon 518 for selecting a picture included in a gallery as a new profile image.

When the terminal user selects the image icon 517, the user terminal 300 may display a basic profile image 513 on the service screen 510. Meanwhile, when the terminal user selects the gallery icon 518, the user terminal 300 may display, on the display unit, an image list screen (not shown) including a plurality of thumbnail images. When any one of the plurality of thumbnail images is selected, the user terminal 300 may display a new profile image including the selected thumbnail image on the service screen 510.

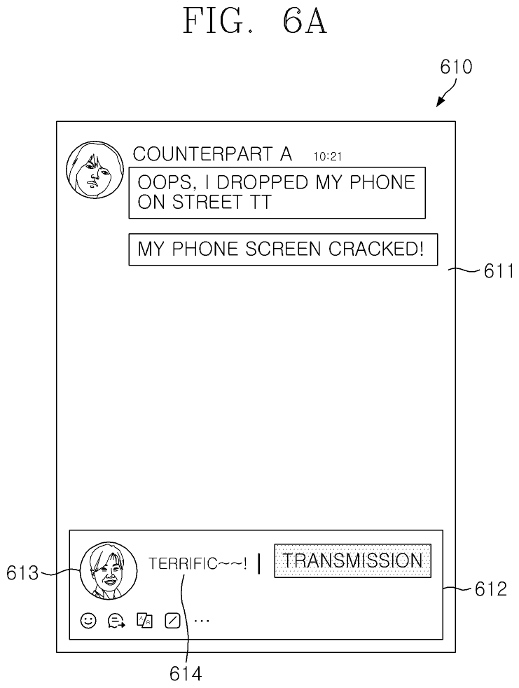

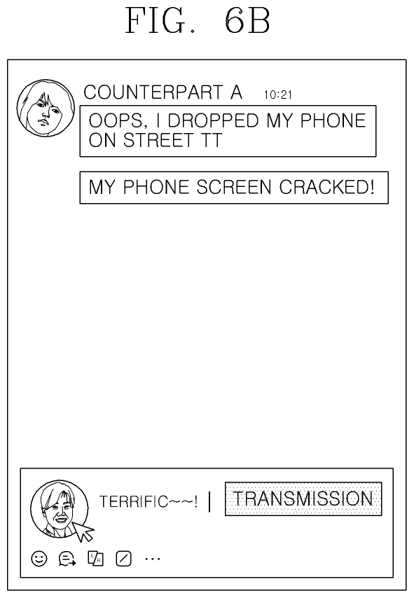

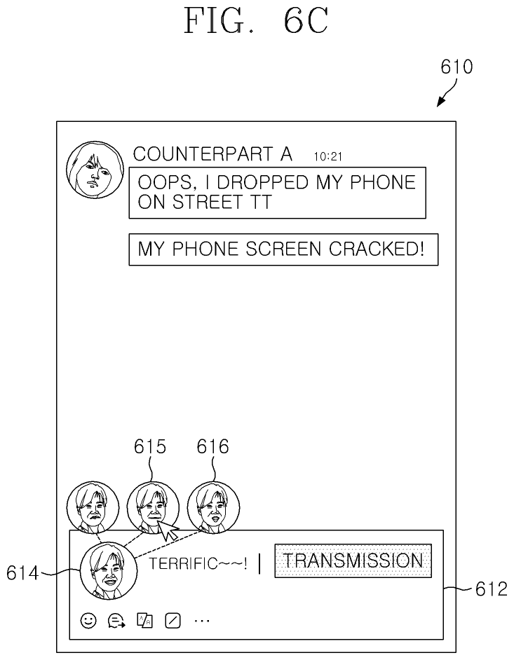

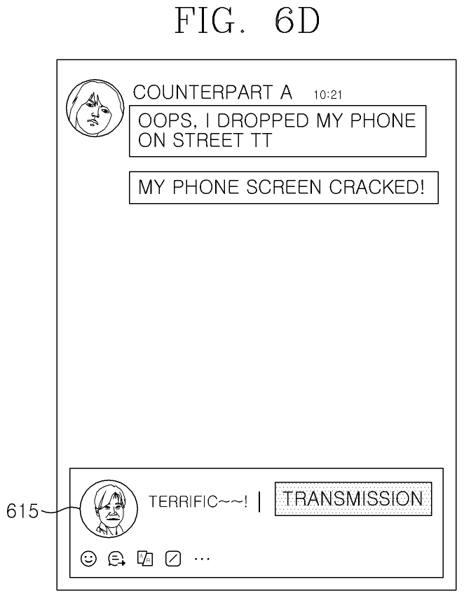

FIGS. 6A to 6D are diagrams for reference to explain a method for the candidate profile image selection of FIG. 4.

Referring to FIGS. 6A to 6D, the user terminal 300 may display a service screen 610 including a chat window 611 and an input window 612 on the display unit. A profile image 613 of a terminal user may be displayed on the input window 612.

When the terminal user inputs a predetermined message 614 through the input window 612 of the service screen 610, the service providing server 200 may extract the terminal user's emotion based on the input message 614, and may identify whether the profile image 513 of the terminal user is an image capable of conveying emotions. As a result of the identification, in case that the profile image 513 of the terminal user is an image capable of conveying emotions, the service providing server 200 may correct the profile image to match the extracted emotion of the user. The service providing server 200 may provide the corrected profile image 613 to the user terminal 300.

The user terminal 300 may display the corrected profile image 613, received from the service providing server 200, on the service screen 610. On the other hand, in case that the facial expression of the corrected profile image 613 displayed on the service screen 610 does not match the terminal user's current emotional state, the terminal user may select another profile image having a facial expression suitable for the context (or intention) of a conversation message 614 input by the terminal user himself or herself.

For example, when a terminal user selects a profile image area of the service screen 610, the user terminal 300 may display, on the service screen 610, a plurality of candidate profile images 614 to 616 having facial expressions different from those of the corrected profile image 613. The plurality of candidate profile images 614 to 616 may be provided from the service providing server 200.

When any one of the plurality of candidate profile images 614 to 616 is selected, the user terminal 300 may change the corrected profile image 613 to the selected candidate profile image 615 and display the selected candidate profile image 615.

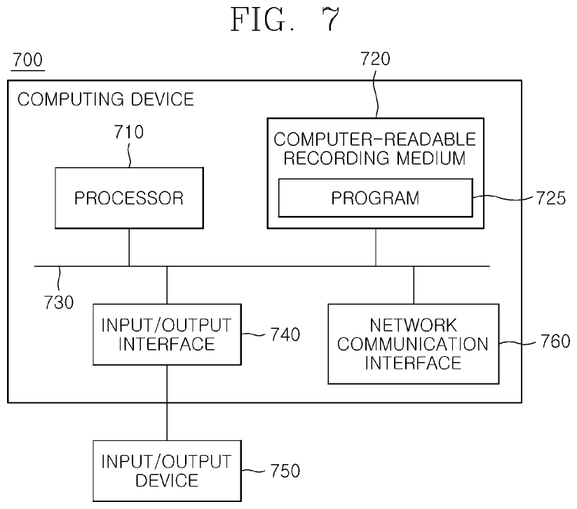

FIG. 7 is a configuration block diagram of a computing device according to an embodiment of the disclosure.

Referring to FIG. 7, a computing device 700 according to an embodiment of the disclosure includes at least one processor 710, a computer-readable storage medium 720, and a communication bus 730. The computing device 700 may be one or more components included in the above profile image correction device or in the elements configuring the profile image correction device.

The processor 710 may cause the computing device 700 to operate according to the above-mentioned exemplary embodiments. For example, the processor 710 may execute one or more programs 725 stored in computer-readable storage medium 720. The one or more programs may include one or more computer executable instructions, which when executed by the processor 710, cause the computing device 700 to perform operations according to the exemplary embodiments.

The computer-readable storage medium 720 is configured to store computer-executable instructions or program code, program data, and/or other suitable form of information. The program 725 stored in computer-readable storage medium 720 includes a set of instructions executable by the processor 710. In an embodiment, the computer-readable storage medium 720 may include a memory (a volatile memory such as random access memory, a non-volatile memory, or a suitable combination thereof), one or more magnetic disk storage devices, optical disk storage devices, flash memory devices, other forms of storage media that can be accessed by the computing device 700 and store desired information, or suitable combinations thereof.

The communication bus 730 interconnects various other components of the computing device 700, including the processor 710 and the computer-readable storage medium 720.

The computing device 700 may also include one or more network communication interfaces 760 and one or more input/output interfaces 740 that provide interfaces for one or more input/output devices 750. The input/output interface 740 and the network communication interface 760 are connected to the communication bus 730.

The input/output device 750 may be connected to other components of the computing device 700 through the input/output interface 740. The exemplary input/output device 750 may include input devices such as, a pointing device (a mouse or trackpad), a keyboard, a touch input device (a touchpad or touchscreen), a voice or sound input device, various types of sensor devices, and/or a photographing device, and/or output devices such as, a display device, a printer, a speaker, and/or a network card. The exemplary input/output device 750 may be included inside the computing device 700, as a component constituting the computing device 700, or may be connected to the computing device 700 as a separate device distinct from the computing device 700.

As described above, the effect of the profile image correction method and device according to embodiments of the disclosure will be described.

According to at least one of the embodiments of the disclosure, an emotion of a terminal user can be extracted based on at least one of user input information and user image information obtained from a user terminal, and a profile image of an online communication service can be automatically corrected based on the extracted emotion.

In addition, according to at least one of the embodiments of the disclosure, by changing the facial expression of the profile image displayed on the online communication service screen in real time, not only the emotions of the terminal user can be effectively conveyed to a conversation partner, but also a lively and immersive conversation can be exchanged with the conversation partner.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

A terminal as described herein, which may be referred to as a computer terminal, may be an electronic or electromechanical hardware device that is used for entering data into and displaying data received from a host computer or a host computing system. A terminal may be limited to inputting and displaying data, or may also have the capability of processing data as well. A terminal with a significant local programmable data processing capability may be referred to as a smart terminal or fat client. A terminal that depends on the host computer or host computing system for its processing power may be referred to as a dumb terminal or thin client. A computer may run terminal emulator software that replicates the function of a terminal, sometimes allowing concurrent use of local programs and access to a distant terminal host system.

What is claimed is:

1. A processor-implemented method for correcting a profile image in an online communication service, the method comprising:
extracting emotion information of a terminal user based on user input information; and
correcting a profile image of the terminal user based on the extracted emotion information.

2. The method of claim 1, wherein the user input information comprises message information received from an input of the terminal user, and
wherein the message information comprises one or both of text information and emoticon information.

3. The method of claim 2, wherein the extracting comprises inputting the message information to a pre-trained text analysis model to extract the emotion information of the terminal user.

4. The method of claim 1, wherein the emotion information of the terminal user comprises one or both of information about a type of emotion and information about an intensity of emotion.

5. The method of claim 1, further comprising:
detecting the profile image of the terminal user; and
determining whether the detected profile image is of an image type capable of conveying emotions.

6. The method of claim 1, wherein the correcting comprises:
extracting a face region of a person included in the profile image by using an object tracking algorithm; and
correcting a facial expression included in the extracted face region according to the extracted emotion information, by using an image synthesis algorithm.

7. The method of claim 1, further comprising transmitting the corrected profile image to a user terminal.

8. The method of claim 1, further comprising receiving user image information including a face image of the terminal user from a user terminal.

9. The method of claim 8, wherein the user input information comprises message information input from the terminal user and typing speed information of the terminal user.

10. The method of claim 9, wherein the extracting further comprises extracting the emotion information of the terminal user based on one or more of first emotion information extracted through the message information, second emotion information extracted through the typing speed information, and third emotion information extracted through the user image information.

11. The method of claim 10, wherein the extracting further comprises inputting the typing speed information to a pre-trained typing analysis model to extract the second emotion information.

12. The method of claim 10, wherein the extracting further comprises:
extracting feature points of the face image included in the user image information by using an image shift algorithm; and
extracting the third emotion information based on the extracted feature points.

13. The method of claim 8, further comprising:
determining whether the profile image of the terminal user is of an image type capable of conveying emotions; and
generating a new profile image based on a face image included in the user image information responsive to the profile image being an image type incapable of conveying emotions.

14. The method of claim 13, further comprising:
determining whether a first face included in the profile image of the terminal user matches a second face included in the user image information responsive to the profile image being the image type incapable of conveying emotions; and
generating a new profile image based on the face image included in the user image information responsive to the first face not matching the second face.

15. The method of claim 1, further comprising determining whether a chat room of the online communication service is a chat room in which emotions can be expressed, based on chat room message information displayed in the chat room.

16. The method of claim 15, wherein the determining comprises:
determining an atmosphere of the chat room based on the chat room message information displayed in the chat room, by using a pre-trained chat room analysis model; and
determining whether the chat room is a chat room in which emotions can be expressed responsive to the determining of the atmosphere.

17. The method of claim 1, further comprising:
generating one or more candidate profile images including facial expressions different from facial expressions included in the corrected profile image responsive to a profile image change request of the terminal user; and
providing the generated candidate profile images to a user terminal.

18. A profile image correction device in an online communication service, the profile image correction device comprising:
one or more processors configured to execute instructions; and
a memory storing the instructions, wherein execution of the plurality of instructions configures one or more of the processors to:
extract emotion information of a terminal user based on user input information; and
perform a correction of a profile image of the terminal user based on the extracted emotion information.

19. The device of claim 18, wherein the user input information comprises message information received from the terminal user, and
wherein the message information comprises one or both of text information and emoticon information.

20. A non-transitory, computer-readable storage medium storing instructions that, when executed by the one or more processors, configure the one or more processors to:
receive user input information from a user terminal of an online communication service;
extract emotion information of a terminal user based on the received user input information; and
correct a profile image of the terminal user based on the extracted emotion information.
